(19) United States
(12) Patent Application Publication
(10) Pub. No.: US 2025/0277925 A1
(43) Pub. Date: Sep. 4, 2025

(54) WAVELENGTH SELECTIVE ABSORPTION FILTER, LIQUID CRYSTAL DISPLAY DEVICE, AND ORGANIC ELECTROLUMINESCENT DISPLAY DEVICE

(71) Applicant: FUJIFILM Corporation, Tokyo (JP)

(72) Inventors: Kunihiro ATSUMI, Kanagawa (JP); Nobutaka FUKAGAWA, Kanagawa (JP)

(73) Assignee: FUJIFILM Corporation, Tokyo (JP)

(21) Appl. No.: 19/201,537

(22) Filed: May 7, 2025

Related U.S. Application Data
(63) Continuation of application No. PCT/JP2023/041655, filed on Nov. 20, 2023.

(30) Foreign Application Priority Data
Nov. 21, 2022 (JP) 2022-185624

(51) Int. Cl. G02B 5/22; G02F 1/1335

(52) U.S. Cl. CPC G02B 5/22; G02F 1/133514

(57) ABSTRACT

A wavelength selective absorption filter including a substrate film and a wavelength selective absorption filter layer disposed in contact with the substrate film, in which the wavelength selective absorption filter layer contains a resin containing a carboxy group, and 0.1 parts by mass or more of a coloring agent having a main absorption wavelength band in a wavelength range of 460 to 520 nm with respect to 100 parts by mass of the resin; and a liquid crystal display device and an organic electroluminescent display device, including the filter.

### CROSS-REFERENCE TO RELATED APPLICATIONS

This application is a Continuation of PCT International Application No. PCT/JP2023/041655 filed on Nov. 20, 2023, which was published under PCT Article 21(2) in Japanese, and which claims priority under 35 U.S.C. § 119(a) to Japanese Patent Application No. 2022-185624 filed in Japan on Nov. 21, 2022. Each of the above applications is hereby expressly incorporated by reference, in its entirety, into the present application.

### BACKGROUND OF THE INVENTION

### 1. Field of the Invention

The present invention relates to a wavelength selective absorption filter, a liquid crystal display device, and an organic electroluminescent display device.

### 2. Description of the Related Art

As an image display device, an organic electroluminescent (OLED) display device, a liquid crystal display device, and the like have been used in recent years.

The liquid crystal display device is widely used year by year as a space-saving image display device with low power consumption. Since a liquid crystal panel displaying an image is a non-light emitting element which does not emit light itself, the liquid crystal display device includes a backlight unit which is disposed on a rear surface of the liquid crystal panel and supplies light to the liquid crystal panel.

The OLED display device is a device which displays an image using self-emission of organic light emitting diode (OLED) elements. Therefore, the OLED display device has advantages that a high contrast ratio, a high color reproducibility, a wide viewing angle, a high-speed responsiveness, and a reduction in thickness and weight can be achieved, as compared with various display devices such as a liquid crystal display device and a plasma display device. In addition to these advantages, in terms of flexibility, the OLED display device is actively researched and developed as a next-generation display device.

In the development of the image display device, a technique of incorporating a wavelength selective absorption filter as a constituent has been known.

For example, in the liquid crystal display device, in a case where a white light emitting diode (LED) is used as a light source for the backlight unit, an attempt has been made to provide a wavelength selective absorption filter in order to block light having unnecessary wavelengths emitted from the white LED. In addition, in the OLED display device, an attempt has been made to provide a wavelength selective absorption filter from the viewpoint of suppressing reflection of external light.

In addition, in recent years, an attempt has been made to provide a wavelength selective absorption filter for the purpose of suppressing a decrease in contrast and improving color reproduction in a bright place, on a display using self-emission such as an OLED element, a micro light emitting diode (LED) element, and a mini LED element.

In particular, regarding the improvement of color reproduction, examples of a system with a wide color reproduction range include an OLED of a three-color (red (R), green (G), and blue (B)) coloring system, a liquid crystal display device using a micro LED, a mini LED, or a quantum dot (QD) light source, and a QD-OLED. In order to further improve the color reproducibility, an attempt has been made to incorporate a wavelength selective absorption filter.

As the wavelength selective absorption filter, for example, WO2019/189463A discloses a color correction filter for a white organic electroluminescent light source, which contains a resin and 0.1 parts by mass or more of a coloring agent having an absorption maximal wavelength in a range of 560 to 620 nm or 460 to 520 nm, with respect to 100 parts by mass of the resin, and has a moisture content of 0.5% by mass or less. According to the above-described color correction filter for a white organic electroluminescent light source disclosed in WO2019/189463A, it is disclosed that color reproducibility of an organic EL display device using a white organic EL light source can be further improved, and light resistance is also excellent.

### SUMMARY OF THE INVENTION

However, in the above-described color correction filter for a white organic electroluminescent light source (wavelength selective absorption filter) disclosed in WO2019/189463A, since adhesiveness between a substrate film (support) used for forming the wavelength selective absorption filter (color correction filter for a white organic EL light source) by coating and a wavelength selective absorption filter layer (color correction filter layer for a white organic EL light source) is low, a step of transferring the substrate film used in the coating and forming step to another substrate film or the like is required in a case of being incorporated into various display devices.

An object of the present invention is to provide a wavelength selective absorption filter in which a substrate film and a wavelength selective absorption filter layer in the wavelength selective absorption filter exhibit excellent adhesiveness, and for example, a wavelength selective absorption filter which enables the substrate film to be used by being incorporated into a display device.

Another object of the present invention is to provide a liquid crystal display device and an organic electroluminescent display device, which include the above-described wavelength selective absorption filter.

As a result of intensive studies in view of the above-described problems, the present inventors have found that excellent adhesiveness between the wavelength selective absorption filter layer and the substrate film can be obtained by using, as a resin constituting the wavelength selective absorption filter layer, a polymer containing a carboxy group, that is, by allowing the wavelength selective absorption filter layer to contain a resin containing a carboxy group.

That is, the above-described object has been achieved by the following method.
<1>
A wavelength selective absorption filter comprising:
a substrate film; and
a wavelength selective absorption filter layer disposed in contact with the substrate film,
in which the wavelength selective absorption filter layer contains a resin containing a carboxy group, and 0.1 parts by mass or more of a coloring agent having a main absorption wavelength band in a wavelength range of 460 to 520 nm with respect to 100 parts by mass of the resin.
<2>
The wavelength selective absorption filter according to <1>,
in which the coloring agent is a squaraine-based coloring agent represented by General

Formula (1),

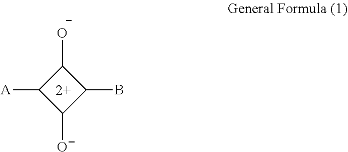

in General Formula (1), A and B each independently represent an aryl group which may have a substituent, a heterocyclic group which may have a substituent, or —CH═G, and G represents a heterocyclic group which may have a substituent.
<3>
The wavelength selective absorption filter according to <1>or <2>,
in which a peeling force between the wavelength selective absorption filter layer and the substrate film is 1 N/25 mm or more.
<4>
A liquid crystal display device comprising:
the wavelength selective absorption filter according to any one of <1>to <3>.
<5>
An organic electroluminescent display device comprising:
the wavelength selective absorption filter according to any one of <1>to <3>.

In the present invention, a numerical range represented by using “to” means a range including numerical values described before and after “to” as a lower limit value and an upper limit value.

In the present invention, in a case where there is a plurality of substituents, linking groups, constitutional units, or the like (hereinafter, referred to as substituents or the like), which are represented by a specific symbol or Formula, or in a case where a plurality of substituents or the like are regulated at the same time, the substituents or the like may be the same or different from each other, unless otherwise specified. The same applies to the definition of the number of substituents or the like. In a case where a plurality of substituents or the like are near (particularly, adjacent to each other), unless otherwise specified, the substituents or the like may be linked to each other to form a ring. In addition, rings, for example, aliphatic rings, aromatic rings, or hetero rings may be further condensed together and thus form a fused ring.

In the present invention, unless otherwise specified, components constituting the wavelength selective absorption filter layer (resin containing a carboxy group, coloring agent having a main absorption wavelength band in a wavelength range of 460 to 520 nm, and other components which may be appropriately contained) may be contained in one kind or two or more kinds in the wavelength selective absorption filter layer.

In the present invention, a polymer may be any of a chain polymerization polymer or a condensation polymerization polymer, and may be any of a homopolymer or a copolymer. In addition, in the case of copolymer, any of a random polymer, a block polymer, or the like may be used.

In the present invention, unless otherwise specified, with regard to a double bond, in a case where E-form and Z-form are present in the molecule, the double bond may be any one of these forms, or may be a mixture thereof.

In the present invention, “composition” includes a mixture in which a component concentration varies within a range in which a desired function is not impaired, in addition to a mixture in which the component concentration is constant (respective components are uniformly dispersed).

In the present invention, “(meth)acrylate” represents any one or both of acrylate and methacrylate, “(meth)acrylic acid” represents any one or both of acrylic acid and methacrylic acid and “(meth)acryloyl” represents any one or both of acryloyl and methacryloyl.

In the wavelength selective absorption filter according to the aspect of the present invention, the substrate film and the wavelength selective absorption filter layer in the wavelength selective absorption filter exhibit excellent adhesiveness. Therefore, the wavelength selective absorption filter according to the aspect of the present invention can be used, for example, by being incorporated into a display device together with the substrate film.

In addition, since the liquid crystal display device and the organic electroluminescent display device according to the aspects of the present invention include the wavelength selective absorption filter according to the aspect of the present invention as it is, in the manufacturing thereof, it is not necessary to transfer the wavelength selective absorption filter layer to another substrate film or the like and then incorporate the substrate film into the display device, and thus manufacturing (assembly) efficiency is favorable.

### BRIEF DESCRIPTION OF THE DRAWINGS

FIG. 1 is a schematic view showing an outline of an embodiment of a liquid crystal display device having a wavelength selective absorption filter according to the embodiment of the present invention.

### DESCRIPTION OF THE PREFERRED EMBODIMENTS

### Wavelength Selective Absorption Filter

The wavelength selective absorption filter according to the embodiment of the present invention (hereinafter, also simply referred to as “filter according to the embodiment of the present invention”) is a wavelength selective absorption filter including a substrate film and a wavelength selective absorption filter layer disposed in contact with the substrate film, in which the wavelength selective absorption filter layer contains a resin containing a carboxy group, and a coloring agent having a main absorption wavelength band in a wavelength range of 460 to 520 nm with a specific proportion with respect to the resin.

The filter according to the embodiment of the present invention can be used, for example, as a film for effectively blocking light having an unnecessary wavelength (light having a wavelength range other than RGB described later) from a backlight light source in a liquid crystal display device, and as a film for effectively blocking light having an unnecessary wavelength (light having a wavelength range other than RGB described later) from a light emitting source in an organic EL display device.

### Wavelength Selective Absorption Filter Layer

### Coloring Agent

The coloring agent contained in the above-described wavelength selective absorption filter layer is a coloring agent having a main absorption wavelength band in a wavelength range of 460 to 520 nm (hereinafter, referred to as a coloring agent A).

Although details will be described later, the above-described wavelength selective absorption filter layer can also contain a coloring agent other than the coloring agent A.

The coloring agent A is not particularly limited as long as it has a main absorption wavelength band in a wavelength range of 460 to 520 nm, and various coloring agents can be used. Many of the coloring agents A exhibit fluorescence.

In the present invention, an expression “having a main absorption wavelength band at a wavelength range of XX to YY nm” means that, in a visible light absorption spectrum (wavelength range: 380 to 750 nm), a wavelength at which an absorption maximal wavelength appears is present in the wavelength range of XX to YY nm. Therefore, in a case where the wavelength is within the above-described wavelength range, the entire absorption band including the wavelength may be within the above-described wavelength range or may extend beyond the above-described wavelength range. In addition, in a case where a plurality of absorption maximal wavelengths are present, it is sufficient that the absorption maximal wavelength at which the maximum absorbance is exhibited is present in the wavelength range of XX to YY nm, and the absorption maximal wavelength other than the absorption maximal wavelength at which the maximum absorbance is exhibited (absorption maximal wavelength at which the non-highest absorbance is exhibited) may be present outside the wavelength range of XX to YY nm.

Specific examples of the coloring agent A include respective coloring agents such as pyrrole methine (PM)-based coloring agents, rhodamine (RH)-based coloring agents, boron dipyrromethene (BODIPY)-based coloring agents, and squaraine (SQ)-based coloring agents.

For example, a commercially available product such as FDB-007 (product name, merocyanine-based coloring agent, manufactured by YAMADA CHEMICAL CO., LTD.) can also be preferably used as the coloring agent A.

In addition, a coloring agent other than the coloring agent A may be appropriately contained within a range in which the effect of the present invention is not impaired.

Among these, as the coloring agent A, a squaraine-based coloring agent is preferable, and a squaraine-based coloring agent represented by General Formula (1) below is more preferable.

In coloring agents represented by each general formula in the present invention, cations are present in a delocalized manner and a plurality of tautomer structures are present. Therefore, in the present invention, in a case where at least one tautomer structure of a certain coloring agent matches each general formula, the coloring agent is considered as the coloring agent represented by the each general formula. Accordingly, a coloring agent represented by a specific general formula can also be said to be a coloring agent having at least one tautomer structure which can be represented by the specific general formula. In the present invention, a coloring agent represented by a general formula may have any tautomer structure as long as at least one tautomer structure of the coloring agent matches the general formula.

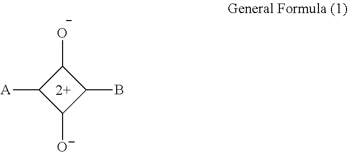

In General Formula (1), A and B each independently represent an aryl group which may have a substituent, a heterocyclic group which may have a substituent, or —CH═G. G represents a heterocyclic group which may have a substituent.

The coloring agent represented by General Formula (1) is the same as a squaraine-based coloring agent represented by General Formula (1), described in paragraphs [0016] to [0024] of WO2019/189463A, and a preferred range thereof is also the same. Therefore, regarding the definition and the preferred range of each substituent in General Formula (1), unless otherwise specified, the description regarding each substituent of the coloring agent represented by General Formula (1), described in paragraphs [0016] to [0024] of WO2019/189463A, can be applied as it is.

The same applies to coloring agents represented by any of General Formulae (2) to (5). That is, the coloring agents represented by any of General Formulae (2) to (5) are the same as the squaraine-based coloring agents represented by any of General Formulae (2) to (5), described in paragraphs [0025] to [0045] of WO2019/189463A, and preferred ranges thereof are also the same. Therefore, regarding the definition and the preferred range of each substituent in General Formulae (2) to (5), unless otherwise specified, the description regarding each substituent of the coloring agents represented by any of General Formulae (2) to (5), described in paragraphs [0025] to [0045] of WO2019/189463A, can be applied as it is.

Examples of a preferred embodiment of the coloring agent represented by General Formula (1) include a coloring agent represented by General Formula (2).

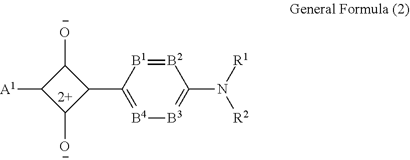

In General Formula (2), A¹ is the same as A in General Formula (1). Among these, a heterocyclic group which is a nitrogen-containing five-membered ring is preferable.

The coloring agent represented by General Formula (2) is preferably a coloring agent represented by any one of General Formula (3), General Formula (4), and General Formula (5).

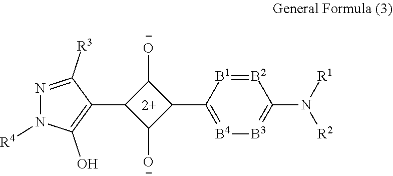

In General Formula (3), R¹ and R² each independently represent a hydrogen atom or a substituent, and have the same meaning as R¹ and R² in General Formula (2), and a preferred range thereof is also the same.

In General Formula (3), B¹ to B⁴ each independently represent a carbon atom or a nitrogen atom, and have the same meaning as B¹ to B⁴ in General Formula (2), and a preferable range thereof is also the same.

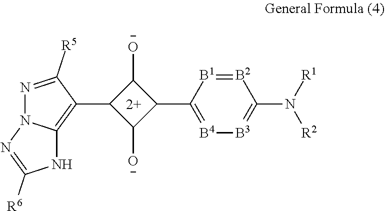

In General Formula (4), R¹ and R² each independently represent a hydrogen atom or a substituent, and have the same meaning as R¹ and R² in General Formula (2), and a preferred range thereof is also the same.

In General Formula (4), B¹ to B⁴ each independently represent a carbon atom or a nitrogen atom, and have the same meaning as B¹ to B⁴ in General Formula (2), and a preferable range thereof is also the same.

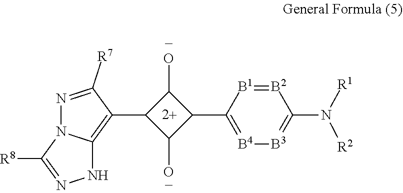

In General Formula (5), R¹ and R² each independently represent a hydrogen atom or a substituent, and have the same meaning as R¹ and R² in General Formula (2), and a preferred range thereof is also the same.

In General Formula (5), B¹ to B⁴ each independently represent a carbon atom or a nitrogen atom, and have the same meaning as B¹ to B⁴ in General Formula (2), and a preferable range thereof is also the same.

In the present invention, in a case of using a squaraine-based coloring agent as the coloring agent A, as the squaraine-based coloring agent, any squaraine coloring agent represented by any one of General Formulae (1) to (5) can be used without particular limitation. Examples thereof include compounds described in JP2006-160618A, WO2004/005981A, WO2004/007447A, Dyes and Pigment, 2001, 49, pp. 161 to 179, WO2008/090757A, WO2005/121098A, and JP2008-275726A.

As specific examples of the coloring agent represented by any one of General Formulae (1) to (5), the description of specific examples of the coloring agent represented by any one of General Formulae (1) to (5), described in paragraphs to of WO2019/189463A, can be adopted as they are.

Examples of a preferred embodiment of the coloring agent represented by General Formula (1) include a coloring agent represented by General Formula (6).

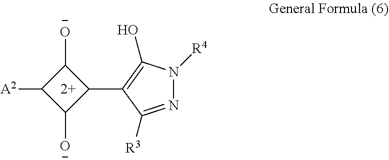

In General Formula (6), R³ and R⁴ each independently represent a hydrogen atom or a substituent, and have the same meaning as R³ and R⁴ in General Formula (3), and a preferred range thereof is also the same.

In General Formula (6), A² has the same meaning as A in General Formula (1). Among these, a heterocyclic group which is a nitrogen-containing five-membered ring is preferable.

The coloring agent represented by General Formula (6) is preferably a coloring agent represented by any one of General Formula (7), General Formula (8), and General Formula (9).

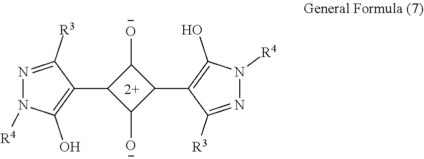

In General Formula (7), R³ and R⁴ each independently represent a hydrogen atom or a substituent, and have the same meaning as R³ and R⁴ in General Formula (3), and a preferred range thereof is also the same. Two R³'s and two R⁴'s may be the same or different from each other.

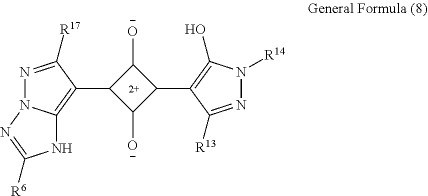

In General Formula (8), R³ and R⁴ each independently represent a hydrogen atom or a substituent, and have the same meaning as R³ and R⁴ in General Formula (3), and a preferred range thereof is also the same.

In General Formula (8), R⁵ and R⁶ each independently represent a hydrogen atom or a substituent, and have the same meaning as R⁵ and R⁶ in General Formula (4), and a preferred range thereof is also the same.

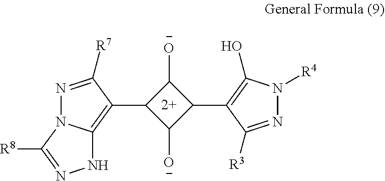

In General Formula (9), R³ and R⁴ each independently represent a hydrogen atom or a substituent, and have the same meaning as R³ and R⁴ in General Formula (3), and a preferred range thereof is also the same.

In General Formula (9), R⁷ and R⁸ each independently represent a hydrogen atom or a substituent, and have the same meaning as R⁷ and R⁸ in General Formula (5), and a preferred range thereof is also the same.

In the present invention, in a case of using a squaraine-based coloring agent as the coloring agent A, as the squaraine-based coloring agent, any squaraine-based coloring agent represented by any one of General Formulae (6) to (9) can be used without particular limitation. Examples thereof can include compounds described in, for example, JP2002-097383A and JP2015-068945A.

In addition, as specific examples of the coloring agent represented by any one of General Formulae (6) to (9), the description of specific examples of the coloring agent represented by any one of General Formulae (6) to (9), described in paragraphs to of WO2019/189463A, can be adopted as they are.

The content of the coloring agent having a main absorption wavelength band in a wavelength range of 460 to 520 nm in the above-described wavelength selective absorption filter layer is, in total, 0.10 parts by mass or more, preferably 0.15 parts by mass or more, more preferably 0.20 parts by mass or more, still more preferably 0.25 parts by mass or more, and particularly preferably 0.30 parts by mass or more with respect to 100 parts by mass of the resin constituting the above-described wavelength selective absorption filter layer.

In addition, the content of the coloring agent having a main absorption wavelength band in a wavelength range of 460 to 520 nm in the above-described wavelength selective absorption filter layer is, in total, usually 1 part by mass or less, preferably 0.60 parts by mass or less, and more preferably 0.45 parts by mass or less with respect to 100 parts by mass of the resin constituting the above-described wavelength selective absorption filter layer.

That is, the content of the coloring agent having a main absorption wavelength band in a wavelength range of 460 to 520 nm in the above-described wavelength selective absorption filter layer is, in total, preferably 0.10 to 1 part by mass, more preferably 0.15 to 1 part by mass, still more preferably 0.20 to 0.60 parts by mass, particularly preferably 0.25 to 0.60 parts by mass, and most preferably 0.30 to 0.45 parts by mass with respect to 100 parts by mass of the resin constituting the above-described wavelength selective absorption filter layer.

As the coloring agent used in the present invention, in addition to the above-described coloring agent A, one kind or two or more kinds of fluorescent coloring agents (coloring agents of a second aspect) may be used in combination, which have a main absorption wavelength band in a wavelength range other than RGB and a main emission wavelength band in a wavelength range corresponding to the wavelength range of RGB.

In the present invention, examples of the wavelength range other than RGB include respective wavelength ranges of 430 nm or less (for example, 380 nm to 430 nm), 480 nm to 510 nm, and 560 nm to 620 nm (preferably, 610 nm or less). In addition, examples of the wavelength range of RGB include respective wavelength ranges of 430 nm to 480 nm, 510 nm to 580 nm (preferably, less than 560 nm), and 610 nm or more (for example, 610 nm to 650 nm; preferably more than 620 nm and 650 nm or less).

In the present invention, the fact that the main absorption wavelength band is in the wavelength range other than RGB means that, in the visible light absorption spectrum (wavelength range: 380 to 750 nm), a wavelength at which the highest absorption intensity (maximum absorption intensity) among the absorption maximal wavelengths is exhibited is present in any of the wavelength range other than RGB. In addition, the fact that the main emission wavelength band is in a wavelength range corresponding to the wavelength range of RGB means that, in the visible light absorption spectrum (wavelength range: 380 to 750 nm), a wavelength at which the highest light emission intensity (maximum light emission intensity) among the maximal light emission wavelengths is exhibited is present in any of the wavelength range of RGB.

The above-described coloring agent of the second aspect is not particularly limited as long as the coloring agent has the above-described properties; and examples thereof include respective fluorescent coloring agents such as anthracene-based fluorescent coloring agents, anthraquinone-based fluorescent coloring agents, arylmethine-based fluorescent coloring agents, azo-based fluorescent coloring agents, azomethine-based fluorescent coloring agents, bimane-based fluorescent coloring agents, coumarin-based fluorescent coloring agents, 1,5-diazabicyclo[3.3.0]octadiene-based fluorescent coloring agents, diketo-pyrrole-based fluorescent coloring agents, naphthalenol-imine-based fluorescent coloring agents, naphthalimide-based fluorescent coloring agents, perylene-based fluorescent coloring agents, phenolphthalein-based fluorescent coloring agents, pyrrole methine-based fluorescent coloring agents, pyran-based fluorescent coloring agents, pyrene-based fluorescent coloring agents, porphycene-based fluorescent coloring agents, porphyrin-based fluorescent coloring agents, quinacridone-based fluorescent coloring agents, rhodamine-based fluorescent coloring agents, rubrene-based fluorescent coloring agents, and stilbene-based fluorescent coloring agents.

Preferred examples thereof include a combination of two or more fluorescent coloring agents among each of the perylene-based fluorescent coloring agents, azo-based fluorescent coloring agents, pyrrole methine-based fluorescent coloring agents, pyran-based fluorescent coloring agents, and coumarin-based fluorescent coloring agents; and more preferred examples thereof include a combination of two or more fluorescent coloring agents among each of the perylene-based fluorescent coloring agents, pyrrole methine-based fluorescent coloring agents, pyran-based fluorescent coloring agents, and coumarin-based fluorescent coloring agents.

### Resin

The above-described wavelength selective absorption filter layer contains a resin containing a carboxy group.

That is, the above-described wavelength selective absorption filter layer contains a resin composed of a polymer containing a carboxy group (hereinafter, also referred to as “carboxy group-containing polymer”) as a matrix resin.

### Carboxy Group-Containing Polymer

The carboxy group-containing polymer may further have an acid group other than the carboxy group. Examples of the acid group other than the carboxy group include a phenolic hydroxyl group, a phosphoric acid group, and a sulfonic acid group.

In a case where the carboxy group-containing polymer is a copolymer, a structure of the polymer may be a random polymer or a regular polymer such as a block.

### Constitutional Unit Having Carboxy Group

The carboxy group-containing polymer preferably has a constitutional unit having a carboxy group.

Examples of the constitutional unit having a carboxy group include a constitutional unit derived from (meth) acrylic acid, crotonic acid, itaconic acid, maleic acid, or fumaric acid. Among these, a constitutional unit derived from (meth) acrylic acid is preferable.

In the carboxy group-containing polymer, a content of the constitutional unit having a carboxy group is preferably 1% to 100% by mole, more preferably 3% to 65% by mole, still more preferably 5% to 45% by mole, and particularly preferably 10% to 45% by mole in a case where the total of all constitutional units of the carboxy group-containing polymer is set to 100% by mole.

One kind of the constitutional unit having a carboxy group may be used alone, or two or more kinds thereof may be used in combination.

### Constitutional Unit Having Aromatic Ring

It is also preferable that the carboxy group-containing polymer has a constitutional unit having an aromatic ring (preferably, an aromatic hydrocarbon ring), in addition to the above-described constitutional unit. Examples thereof include a constitutional unit derived from a (meth)acrylate having an aromatic ring (specifically, benzyl (meth)acrylate, phenethyl (meth)acrylate, phenoxyethyl (meth)acrylate, or the like) or a styrene.

In the carboxy group-containing polymer, a content of the constitutional unit having an aromatic ring is preferably 0% to 97% by mole, more preferably 0% to 95% by mole, and still more preferably 0% to 90% by mole in a case where the total of all constitutional units of the carboxy group-containing polymer is set to 100% by mole.

One kind of the constitutional unit having an aromatic ring may be used alone, or two or more kinds thereof may be used in combination.

### Constitutional Unit Having Alicyclic Structure

It is also preferable that the carboxy group-containing polymer has a constitutional unit having an alicyclic structure, in addition to the above-described constitutional units.

Examples of the alicyclic structure include a tricyclo[5.2.1.0^{2,6}]decane ring structure (also referred to as tetrahydrodicyclopentadiene; a monovalent group is dicyclopentanyl), a tricyclo[5.2.1.0^{2,6}]decane-3-ene ring structure (also referred to as 5,6-dihydrodicyclopentadiene; a monovalent group is dicyclopentenyl), an isobornane ring structure (a monovalent group is isobornyl), an adamantane ring structure (a monovalent group is adamantyl), and a cyclohexane ring structure (a monovalent group is cyclohexyl).

Examples of the constitutional unit having an alicyclic structure include a constitutional unit derived from a (meth)acrylate having an alicyclic structure. Specific examples thereof include a constitutional unit derived from dicyclopentanyl (meth)acrylate, dicyclopentenyl (meth)acrylate, isobornyl (meth)acrylate, adamantyl (meth)acrylate, cyclohexyl (meth)acrylate, or the like.

In the carboxy group-containing polymer, a content of the constitutional unit having an alicyclic structure is preferably 0% to 97% by mole, more preferably 0% to 95% by mole, and still more preferably 0% to 90% by mole in a case where the total of all constitutional units of the carboxy group-containing polymer is set to 100% by mole.

One kind of the constitutional unit having an alicyclic structure may be used alone, or two or more kinds thereof may be used in combination.

### Other Constitutional Units

The carboxy group-containing polymer may have other constitutional units in addition to the above-described constitutional units.

Examples of the other constitutional units include a constitutional unit derived from methyl (meth)acrylate.

In the carboxy group-containing polymer, a content of the other constitutional units is preferably 0% to 70% by mole, more preferably 0% to 50% by mole, and still more preferably 0% to 20% by mole in a case where the total of all constitutional units of the carboxy group-containing polymer is set to 100% by mole.

One kind of the other constitutional units may be used alone, or two or more kinds thereof may be used in combination.

Among these, the carboxy group-containing polymer preferably has at least one of the above-described constitutional unit having an aromatic ring or the above-described constitutional unit having an alicyclic structure, in addition to the above-described constitutional unit having a carboxy group; and from the viewpoint of further improving the adhesiveness between the wavelength selective absorption filter layer and the substrate film, the carboxy group-containing polymer more preferably has at least the above-described constitutional unit having an alicyclic structure, in addition to the above-described constitutional unit having a carboxy group.

### Other Components

The above-described wavelength selective absorption filter layer may contain a polarization-improving agent, a discoloration preventer, a matting agent, a leveling agent, or the like, in addition to the above-described coloring agent and matrix resin.

### Polarization-Improving Agent

The above-described wavelength selective absorption filter layer preferably contains a polarization-improving agent. By quenching the fluorescence emitted from the coloring agent with a polarization-improving agent, an organic EL display device can improve the degree of polarization of a polarizing plate having the purpose of preventing reflected glare of external light.

The polarization-improving agent used in the present invention is preferably an electron-donating quencher or an electron-accepting quencher.

The electron-donating quencher used in the present invention is a quencher which deactivates the coloring agent in the excited state to the ground state by donating an electron to SOMO of the lower energy level among two SOMO's of the coloring agent in the excited state and then by receiving an electron from SOMO of the higher energy level in the coloring agent.

The electron-accepting quencher used in the present invention is a quencher which deactivates the coloring agent in the excited state to the ground state by accepting an electron from SOMO of the higher energy level among two SOMO's of the coloring agent in the excited state and then by donating an electron to SOMO of the lower energy level in the coloring agent.

As the electron-donating quencher and the electron-accepting quencher used in the present invention, the description and specific examples thereof regarding the electron-donating quencher and the electron-accepting quencher, described in paragraphs [0104] to [0220] of WO2019/189463A, can be adopted as they are.

A content of the polarization-improving agent in the above-described wavelength selective absorption filter layer is preferably 0% to 6% by mass, more preferably 0.1% to 5% by mass, and still more preferably 0.3% to 4.5% by mass. By controlling the addition amount of the polarization-improving agent to the above-described upper limit value or less, the degree of polarization can be improved without causing side effects of the above-described wavelength selective absorption filter layer, such as discoloration.

Coloring Agent with Built-In Polarization-Improving Agent

It is also preferable that the polarization-improving agent used in the present invention is also linked to the coloring agent by a covalent bond through a linking group, as necessary, to form a coloring agent with a built-in polarization-improving agent. A coloring agent having such a form is also included in the squaraine-based coloring agent of Formula (1), defined in the present invention.

The energy levels of a coloring agent portion and a polarization-improving agent portion in the coloring agent with a built-in polarization-improving agent of the present invention can be calculated by the same method as the above-described calculation method of the energy levels of the coloring agent and the polarization-improving agent. In the measurement of the potential, two oxidation potentials are detected from the coloring agent with a built-in polarization-improving agent used in the present invention, but a value close to the oxidation potential of the coloring agent having no built-in polarization-improving agent is defined as the oxidation potential of the coloring agent portion, and a value far therefrom is defined as the oxidation potential of the polarization-improving agent portion.

As specific examples of the coloring agent with a built-in polarization-improving agent used in the present invention, the description and specific examples regarding the coloring agent with a built-in polarization-improving agent, described in paragraphs [0223] to [0234] of WO2019/189463A, can be adopted as they are.

In a case where the coloring agent with a built-in polarization-improving agent is used, a content of the coloring agent with a built-in polarization-improving agent in the above-described wavelength selective absorption filter layer is set to the content of the coloring agent having a main absorption wavelength band in a wavelength range of 460 to 520 nm in the above-described wavelength selective absorption filter layer. It is sufficient that the content of the coloring agent with a built-in polarization-improving agent is 0.1 parts by mass or more with respect to 100 parts by mass of the resin constituting the above-described wavelength selective absorption filter layer.

### Discoloration Preventer

The above-described wavelength selective absorption filter layer preferably contains a discoloration preventer. As the discoloration preventer used in the present invention, antioxidants described in paragraphs [0143] to [0165] of WO2015/005398A, radical scavengers described in paragraphs [0166] to [0199] of WO2015/005398A, and deterioration inhibitors described in paragraphs [0205] and [0206] of WO2015/005398A are can be used.

In addition, as the discoloration preventer used in the present invention, a compound represented by General Formula (IV) and a compound represented by General Formula [III], described in paragraphs [0237] to [0251] of WO2019/189463A, can be used.

A content of the discoloration preventer in the above-described wavelength selective absorption filter layer is preferably 0% to 5% by mass, more preferably 0% to 3% by mass, and still more preferably 0% to 2% by mass. By controlling the addition amount of the discoloration preventer to the above-described upper limit value or less, fastness of the coloring agent can be improved without causing side effects of the above-described wavelength selective absorption filter layer, such as discoloration.

### Leveling Agent

A leveling agent (surfactant) can be appropriately mixed in the above-described wavelength selective absorption filter layer. Examples of the leveling agent include a known compound in the related art, and a fluorine-containing surfactant is particularly preferable. Specific examples thereof include compounds described in paragraph Nos. [0028] to [0056] of JP2001-330725A; and preferred examples thereof include a copolymer consisting of a constitutional unit having a fluorine-substituted alkyl group and a constitutional unit derived from an alkyl (meth)acrylate, in a copolymer represented by Formula (IV) described in paragraph No. [0054] of JP2001-330725A.

A content of the leveling agent in the above-described wavelength selective absorption filter layer is appropriately adjusted according to the purpose.

The above-described wavelength selective absorption filter layer may contain, in addition to the above-described respective components, a low molecular weight plasticizer, an oligomer-based plasticizer, a retardation modifier, an ultraviolet absorber, a deterioration inhibitor, a peeling accelerator, an infrared absorber, an antioxidant, a filler, a solubilizer, or the like.

### Substrate Film

The substrate film in the filter according to the embodiment of the present invention will be described in the following description of a manufacturing method of the wavelength selective absorption filter.

### Manufacturing Method of Wavelength Selective Absorption Filter

The above-described wavelength selective absorption filter layer can be manufactured by a method (coating method) of forming a coating layer on a substrate film by a conventional method, and stretching can be appropriately combined. In this manner, the filter according to the embodiment of the present invention, in which the wavelength selective absorption filter layer is disposed in contact with the substrate film, can be manufactured.

### Coating Method

In the coating method, a solution of a material (hereinafter, also referred to as “filter material”) for forming the wavelength selective absorption filter layer is applied onto the substrate film to form the coating layer. A surface of the coating layer opposite to the surface in contact with the substrate film can be used by laminating another member through an adhesive layer in a subsequent step. In addition, in a state in which the polymer solution or the coating layer is stacked on the substrate film, the substrate film can be appropriately stretched.

The solvent used for the solution of the filter material can be appropriately selected from the viewpoint that the filter material can be dissolve or dispersed, a uniform surface state can be easily achieved during the coating step and drying step, liquid preservability can be secured, an appropriate saturated vapor pressure is provided, and the like.

### Addition of Coloring Agent

A timing of adding the above-described coloring agent to the filter material is not particularly limited as long as the coloring agent is added at the time of film formation. For example, the coloring agent may be added at the time of synthesizing the matrix resin, or may be mixed with the filter material at the time of preparing a coating liquid for the filter material.

### Substrate Film

A film thickness of the substrate film used for forming the above-described wavelength selective absorption filter layer by the coating method or the like is preferably 5 to 100 μm, more preferably 10 to 75 μm, and still more preferably 15 to 55 μm. In a case where the film thickness is equal to or more than the above-described preferred lower limit value (for example, 5 μm or more), sufficient mechanical strength is likely to be secured, and failure such as curling, wrinkling, and buckling is unlikely to occur, which is preferable. In addition, in a case where the film thickness is equal to or less than the above-described preferred upper limit value (for example, 100 μm or less), in a case of storing the multilayer film including the above-described wavelength selective absorption filter layer and the substrate film, for example, in a long roll form, a surface pressure applied to the multilayer film is easily adjusted to an appropriate range, and the adhesion is less likely to be defective, which is preferable.

A surface energy of the substrate film is not particularly limited, but the adhesiveness (adhesive force) between the wavelength selective absorption filter layer and the substrate film can be adjusted by adjusting a relationship between the surface energy of the filter material and the coating solution and the surface energy of the surface of the substrate film, on the side where the wavelength selective absorption filter layer is to be formed. In a case where the difference in surface energy is reduced, the adhesive force tends to increase, and in a case where the difference in surface energy is increased, the adhesive force tends to decrease, and thus the surface energy can be set appropriately. In the present invention, it is preferable to reduce the difference in surface energy.

The surface energy of the substrate film can be calculated from a contact angle value between water and methylene iodide using the method of Owens. For measurement of the contact angle, for example, DM901 (manufactured by Kyowa Interface Science Co., Ltd., contact angle meter) can be used.

The surface energy of the surface of the substrate film, on the side where the wavelength selective absorption filter layer is to be formed, is preferably 41.0 to 48.0 mN/m and more preferably 42.0 to 48.0 mN/m. In a case where the surface energy is 41.0 mN/m or more, uniformity of the thickness of the wavelength selective absorption filter layer is increased, which is preferable; and in a case where the surface energy is 48.0 mN/m or less, it is preferable from the viewpoint of the adhesiveness of the wavelength selective absorption filter layer to the substrate film.

In addition, surface unevenness of the substrate film is not particularly limited, but can be adjusted, for example, for the purpose of preventing adhesion defects in a case where the wavelength selective absorption filter (multilayer film) according to the embodiment of the present invention is stored in a long roll form, depending on the relationship between the surface energy, the hardness, and the surface unevenness of the surface of the wavelength selective absorption filter layer and the surface energy and the hardness of the surface of the substrate film opposite to the side where the wavelength selective absorption filter layer is formed. In a case where the surface unevenness is increased, the adhesion defects tend to be suppressed, and in a case where the surface unevenness is reduced, the surface unevenness of the wavelength selective absorption filter tends to decrease and the haze of the wavelength selective absorption filter tends to be small, and thus the surface unevenness can be set appropriately.

As such a substrate film, a film formed of a commonly used material or a commonly used film can be appropriately used. Specific examples of the material constituting the substrate film include a polyester-based polymer such as polyethylene terephthalate, an olefin-based polymer, a cycloolefin-based polymer, a (meth)acrylic polymer, a cellulose-based polymer, and a polyamide-based polymer. In addition, a surface treatment can be appropriately performed for the purpose of adjusting the surface properties of the substrate film. For example, a corona treatment, a room temperature plasma treatment, or a saponification treatment can be carried out to increase the surface energy; and a silicone treatment, a fluorine treatment, an olefin treatment, or the like can be carried out to decrease the surface energy.

### Peeling Force Between Wavelength Selective Absorption Filter Layer and Substrate Film

In a case where the above-described wavelength selective absorption filter layer is formed by the coating method, a peeling force between the above-described wavelength selective absorption filter layer and the substrate film can be controlled by adjusting the filter material (material for forming the wavelength selective absorption filter layer), the material of the substrate film, an internal strain of the wavelength selective absorption filter layer, and the like.

In the present invention, according to JIS (Japanese Industrial Standards) Z-0237 (2022), the peeling force measured by a test of peeling off the substrate film in a 90° direction (90° peeling test) under conditions of a measurement temperature of 25° C., a relative humidity of 60%, a load cell of 50 N, and a peeling rate of 300 mm/min is preferably 1 N/25 mm or more, more preferably 5 N/25 mm or more, and still more preferably 8 N/25 mm or more, and it is particularly preferable that the substrate film is not peeled off under the peeling conditions. In a case where the peeling force is 1 N/25 mm or more, it is possible to prevent poor adhesion during the manufacturing process and/or during use of the display device in a case where the filter according to the embodiment of the present invention is directly incorporated into an organic EL display device or a liquid crystal display device.

Details of the peeling test are as described in Examples described later.

In addition, the expression that the substrate film is not peeled off under the peeling conditions means that the peeling does not occur between the above-described wavelength selective absorption filter layer and the substrate film; and the peeling occurs at a portion of the adhesive used for bonding the wavelength selective absorption filter layer to the glass substrate in order to perform the peeling test, or the wavelength selective absorption filter itself is broken.

### Film Thickness of Wavelength Selective Absorption Filter Layer

A film thickness of the above-described wavelength selective absorption filter layer is preferably 1 to 18 μm, more preferably 1 to 12 μm, and still more preferably 1 to 8 μm. By adding the coloring agent to the wavelength selective absorption filter layer having such a film thickness at a predetermined concentration, fluorescence emitted by the coloring agent can be further suppressed. In addition, the effect of the quencher and/or the discoloration preventer is also likely to be exhibited.

In the present invention, the film thickness of 1 to 18 μm means that the thickness of the filter is within a range of 1 to 18 μm at any portion. The same applies to the film thicknesses of 1 to 12 μm and 1 to 8 μm. The film thickness can be measured with an electronic micrometer manufactured by ANRITSU CORPORATION.

### Absorbance of Wavelength Selective Absorption Filter Layer

An absorbance of the above-described wavelength selective absorption filter layer at a wavelength of 500 nm is preferably 0.05 or more and 4.0 or less. The absorbance is more preferably 0.01 or more and 3.0 or less, and still more preferably 0.1 or more and 2.0 or less.

In a case of incorporating the filter according to the embodiment of the present invention, in which the absorbance of the above-described wavelength selective absorption filter layer is adjusted to be in the above-described range, into an organic EL display device or a liquid crystal display device, display performance with better color reproducibility is obtained.

The absorbance of the above-described wavelength selective absorption filter layer can be adjusted by the type and the addition amount of the coloring agent.

### Moisture Content of Wavelength Selective Absorption Filter Layer

From the viewpoint of durability, a moisture content of the above-described wavelength selective absorption filter layer is preferably 0.5% by mass or less, and more preferably 0.3% by mass or less, regardless of the film thickness. In the present invention, the “moisture content” is a value measured under conditions of 25° C. and a relative humidity of 80%.

In the present specification, the moisture content of the above-described wavelength selective absorption filter layer can be measured using a sample having a thick film thickness as necessary. The moisture content can be calculated by humidity-conditioning the sample for 24 hours or longer, measuring a moisture content (g) by the Karl Fischer method with a water measuring instrument and a sample drying apparatus “CA-03” and “VA-05” (both manufactured by Mitsubishi Chemical Corporation), and dividing the moisture content (g) by the sample mass (g, including the moisture content).

### Treatment of Wavelength Selective Absorption Filter

The wavelength selective absorption filter obtained as described above is preferably subjected to a hydrophilization treatment by a glow discharge treatment, a corona discharge treatment, an alkali saponification treatment, or the like according to a conventional method; and a corona discharge treatment is most preferably used. It is also preferable to apply the method described in JP1994-094915A (JP-H6-094915A) and JP1994-118232A (JP-H6-118232A).

In addition, a heat treatment step, a superheated steam contact step, an organic solvent contact step, or the like can be performed on the obtained wavelength selective absorption filter as necessary. In addition, a surface treatment may be appropriately performed.

### Liquid Crystal Display Device

The liquid crystal display device according to the embodiment of the present invention includes the wavelength selective absorption filter according to the embodiment of the present invention.

In the liquid crystal display device according to the embodiment of the present invention, the wavelength selective absorption filter according to the embodiment of the present invention may be used as at least any of a polarizing plate-protective film or an adhesive layer, which will be described later, or may be included in a backlight unit used in the liquid crystal display device.

It is preferable that the liquid crystal display device includes the wavelength selective absorption filter, polarizing plates including a polarizer and a polarizing plate-protective film, an adhesive layer, and a liquid crystal cell, and it is preferable that the polarizing plates are attached to the liquid crystal cell through the adhesive layer. In the liquid crystal display device, the wavelength selective absorption filter may also serve as the polarizing plate-protective film or the adhesive layer. That is, it is divided into a case where the liquid crystal display device includes polarizing plates including a polarizer and the wavelength selective absorption filter (polarizing plate-protective film), an adhesive layer, and a liquid crystal cell, and a case where the liquid crystal display device includes polarizing plates including a polarizer and a polarizing plate-protective film, the wavelength selective absorption filter (adhesive layer), and a liquid crystal cell.

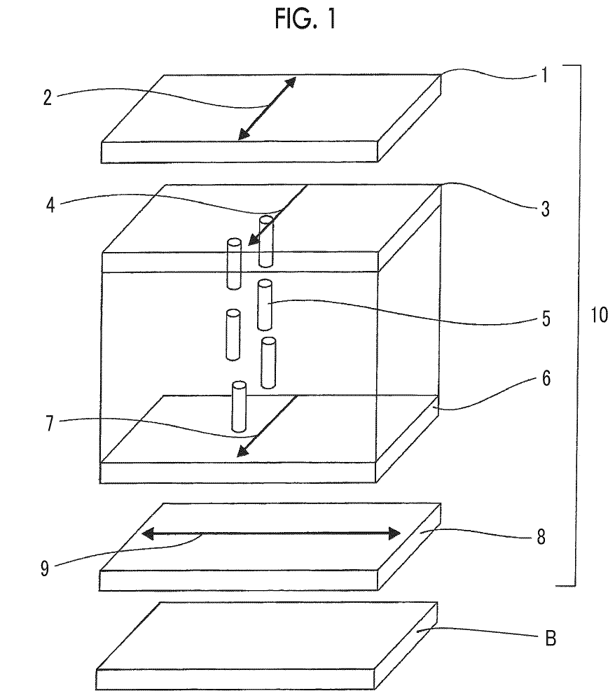

FIG. 1 is a schematic view showing an example of the liquid crystal display device according to the embodiment of the present invention. In FIG. 1, a liquid crystal display device 10 consists of a liquid crystal cell having a liquid crystal layer 5 and an upper electrode substrate 3 of the liquid crystal cell and a lower electrode substrate 6 of the liquid crystal cell, disposed above and below the liquid crystal layer 5, and an upper polarizing plate 1 and a lower polarizing plate 8 disposed on both sides of the liquid crystal cell. A color filter layer may be laminated on the upper electrode substrate 3 or the lower electrode substrate 6. On a rear surface of the above-described liquid crystal display device 10, a backlight is disposed. As a light source of the backlight, those described in the above backlight unit can be used.

It is preferable that each of the upper polarizing plate 1 and the lower polarizing plate 8 has a configuration in which two polarizing plate-protective films and a polarizer are laminated so as to sandwich the polarizer with the polarizing plate-protective films, and in the liquid crystal display device 10, at least one polarizing plate is a polarizing plate including the wavelength selective absorption filter according to the embodiment of the present invention.

In addition, in the liquid crystal display device 10, the above-described liquid crystal cell and the polarizing plate (upper polarizing plate 1 and/or lower polarizing plate 8) may be bonded together through an adhesive layer (not shown). In this case, the wavelength selective absorption filter according to the embodiment of the present invention may also serve as the adhesive layer described above.

The liquid crystal display device 10 includes an image direct vision-type liquid crystal display device, an image projection-type liquid crystal display device, and an optical modulation-type liquid crystal display device. The present invention is effective for an active matrix liquid crystal display device using a three-terminal or two-terminal semiconductor element such as a TFT and a metal-insulator-metal (MIM). Needless to say, the present invention is also effective for a passive matrix liquid crystal display device represented by a super twisted nematic (STN) mode, called time-division driving.

In a case where the wavelength selective absorption filter according to the embodiment of the present invention is included in the backlight unit, the polarizing plate of the liquid crystal display device may be a normal polarizing plate (polarizing plate not including the wavelength selective absorption filter according to the embodiment of the present invention) or a polarizing plate including the wavelength selective absorption filter according to the embodiment of the present invention. In addition, the adhesive layer may be a typical adhesive layer (not the wavelength selective absorption filter according to the embodiment of the present invention), or may be an adhesive layer by the wavelength selective absorption filter according to the embodiment of the present invention.

A liquid crystal display device in an in plane switching (IPS) mode, described in paragraphs [0128] to [0136] of JP2010-102296A, is preferable as the liquid crystal display device according to the embodiment of the present invention, except that the wavelength selective absorption filter according to the embodiment of the present invention is used. That is, the description of the liquid crystal display device in the IPS mode, described in JP2010-102296A, can be preferably adopted to the liquid crystal display device according to the embodiment of the present invention, except that the liquid crystal display device according to the embodiment of the present invention includes the wavelength selective absorption filter according to the embodiment of the present invention as described above.

### Polarizing Plate

The polarizing plate used in the present invention includes a polarizer and at least one polarizing plate-protective film.

The polarizing plate used in the present invention is preferably a polarizing plate having a polarizer and polarizing plate-protective films on both surfaces of the polarizer, and it is preferable that at least one surface of the polarizer includes the wavelength selective absorption filter according to the embodiment of the present invention as the polarizing plate-protective film. The opposite surface of the polarizer to the surface having the wavelength selective absorption filter according to the embodiment of the present invention (polarizing plate-protective film according to the present invention) may have a normal polarizing plate-protective film.

Usually, a film thickness of the polarizing plate-protective film is preferably 5 to 120 μm and more preferably 10 to 100 μm. A thinner film is preferable in that, in a case of being incorporated in the liquid crystal display device, display unevenness over time in high temperature and high humidity is less likely to occur. On the other hand, in a case where the film is too thin, it is difficult to handle the film stably in a case of manufacturing the film and producing the polarizing plate. In a case where the wavelength selective absorption filter according to the embodiment of the present invention also serves as the polarizing plate-protective film, it is preferable that the thickness of the wavelength selective absorption filter satisfies the above-described range.

### Performance of Polarizing Plate

The polarizing plate used in the present invention has a degree of polarization of preferably 99.950% or more, more preferably 99.970% or more, and most preferably 99.990% or more.

In the present invention, the degree of polarization of the polarizing plate is calculated by the following expression from an orthogonal transmittance and a parallel transmittance measured at a wavelength of 380 to 700 nm using an automatic polarizing film measurement instrument: VAP-7070 (product name, manufactured by JASCO Corporation).

$$Degree of polarization ( \% ) = {[ \begin{matrix}( Parallel transmittance - Orthogonal transmittance ) / \\ ( Parallel transmittance + Orthogonal tranmittance )\end{matrix} ]}^{1 / 2} \times 100$$

The degree of polarization can be measured as follows. Two samples (5 cm×5 cm) in which a polarizing plate is attached to glass through an adhesive are produced. The orthogonal transmittance and the parallel transmittance are measured by setting a glass side of the sample toward a light source. The two samples are measured, and the average values thereof are defined as the orthogonal transmittance and the parallel transmittance, respectively. In a case of investigating the influence on the degree of polarization with the polarizing plate-protective film, usually, the polarizing plate-protective film to be evaluated is attached to the glass while being disposed on the glass side.

Other preferred optical properties of the polarizing plate used in the present invention are described in [0238] to [0255] of JP2007-086748A, and it is preferable to satisfy these properties.

### Shape and Configuration

The shape of the polarizing plate used in the present invention includes not only a polarizing plate of an aspect of a film piece cut into a size so as to be incorporated in the liquid crystal display device as it is, but also a polarizing plate of an aspect in which the polarizing plate is produced in a longitudinal shape by a continuous production and wound up in a rolled shape (for example, an aspect having a roll length of 2500 m or more or 3900 m or more). In order to use the polarizing plate as a large-sized screen liquid crystal display device, the width of the polarizing plate is preferably 1470 mm or more.

The polarizing plate used in the present invention is configured of a polarizer and at least one polarizing plate-protective film, but it is also preferable that the polarizing plate is further configured by attaching a separate film on one surface of the polarizing plate.

The separate film is used for the purpose of protecting the polarizing plate during the shipping of the polarizing plate and the inspection of product. The separate film is used for the purpose of covering an adhesive layer which is attached to a liquid crystal plate, and used on a surface where the polarizing plate is attached to the liquid crystal plate.

### Polarizer

The polarizer used for the polarizing plate used in the present invention will be described.

The polarizer which can be used for the polarizing plate used in the present invention is preferably configured of polyvinyl alcohol (PVA) and a dichroic molecule, but as described in JP1999-248937A (JP-H11-248937A), a polyvinylene-based polarizer in which a polyene structure is generated by dehydrating PVA or dechlorinating polyvinyl chloride and aligning the polyene structure can also be used.

### Film Thickness of Polarizer

The film thickness of the polarizer before stretching is not particularly limited, but from the viewpoint of stability of retaining film and homogeneity of stretching, is preferably 1 μm to 1 mm and particularly preferably 5 to 200 μm. In addition, as described in JP2002-236212A, a thin PVA film in which the stress generated in a case of being stretched 4 to 6 times in water is 10 N or less may be used.

### Method of Manufacturing Polarizer

The method of manufacturing the polarizer is not particularly limited, and for example, it is preferable that the polarizer is configured by form PVA into a film and introducing the dichroic molecule to the film. The PVA film can be produced by the method described in paragraphs [0213] to [0237] of JP2007-086748A and by the description of JP3342516B, JP1997-328593A (JP-H09-328593A), JP2001-302817A, JP2002-144401A, and the like.

### Method of Laminating Polarizer and Polarizing Plate-Protective Film

The polarizing plate used in the present invention is manufactured by adhering (laminating) at least one polarizing plate-protective film (preferably, wavelength selective absorption filter according to the embodiment of the present invention) on at least one surface of the above-described polarizer.

The polarizing plate used in the present invention is preferably produced by a method in which a polarizing plate-protective film is subjected to an alkali treatment, and is attached, using a completely saponified polyvinyl alcohol aqueous solution, to both surfaces of a polarizer produced by immersing and stretching a polyvinyl alcohol film in an iodine solution.

Examples of an adhesive used to attach the treated surface of the polarizing plate-protective film to the polarizer include polyvinyl alcohol-based adhesives such as polyvinyl alcohol and polyvinyl butyral and vinyl-based latex such as butyl acrylate.

In the polarizing plate used in the present invention, a method of attaching the polarizing plate-protective film to the polarizer is preferably a method in which the polarizing plate-protective film is attached to the polarizer so that a transmission axis of the polarizer and a slow axis of the polarizing plate-protective film are substantially parallel, orthogonal, or 45°.

The slow axis can be measured by various known methods, for example, using a birefringence meter (KOBRADH, manufactured by Oji Scientific Instruments).

Here, “substantially parallel” refers to that the direction of the main refractive index nx of the polarizing plate-protective film and the direction of the transmission axis of the polarizing plate intersect at an angle within ±5°, preferably at an angle within ±1°, and more preferably angle within ±0.5°. In a case where the intersecting angle is within 1°, polarization performance under polarizing plate crossed nicols is less likely to be deteriorated and light leakage does not easily occur, which is preferable.

The same applies to being substantially orthogonal or 45°, and the description in which the direction of the main refractive index nx and the direction of the transmission axis are orthogonal or 45° means that the angle at which the direction of the main refractive index nx and the direction of the transmission axis intersect is within a range of ±5° with respect to an exact angle of being orthogonal and 45°, and the difference with respect to the exact angle is preferably within a range of ±1° and more preferably within a range of ±0.5°.

### Functionalization of Polarizing Plate

The polarizing plate used in the present invention is preferably used as a functionalized polarizing plate complexed with an antireflection film for improving visibility of a display, a luminance improving film, or an optical film having a functional layer such as a hard coat layer, a forward scattering layer, an antiglare layer, an antifouling layer, and an antistatic layer. The antireflection film for functionalization, the luminance improving film, other functional optical films, the hard coat layer, the forward scattering layer, and the antiglare layer are described in paragraphs [0257] to [0276] of JP2007-086748A, and a functionalized polarizing plate can be produced based on the description.

It is sufficient that the polarizing plate according to the present invention includes the wavelength selective absorption filter according to the embodiment of the present invention; and it is preferable that the wavelength selective absorption filter according to the embodiment of the present invention is included as the polarizing plate-protective film on at least one surface of the polarizer, and it is more preferable that the wavelength selective absorption filter according to the embodiment of the present invention is included as the polarizing plate-protective film such that the substrate film is on the polarizer side.

In the polarizing plate according to the present invention, the above description regarding the polarizing plate used in the present invention can be adopted, except that the polarizing plate includes the wavelength selective absorption filter according to the embodiment of the present invention.

### Adhesive Layer

In the liquid crystal display device according to the embodiment of the present invention, the polarizing plate is preferably attached to the liquid crystal cell through an adhesive layer. The wavelength selective absorption filter according to the embodiment of the present invention may also serve as the adhesive layer described above; and it is more preferable that the wavelength selective absorption filter layer in the wavelength selective absorption filter according to the embodiment of the present invention also serves as the above-described adhesive layer and the substrate film is on the polarizing plate side. In a case where the wavelength selective absorption filter according to the embodiment of the present invention does not serve as the adhesive layer, a normal adhesive layer can be used as the adhesive layer.

The adhesive layer is not particularly limited as long as the adhesive layer can attach the polarizing plate to the liquid crystal cell, and for example, an acrylic type, a urethane type, polyisobutylene, or the like is preferable.

In a case where the wavelength selective absorption filter according to the embodiment of the present invention additionally serves as the adhesive layer, the adhesive layer contains the above-described coloring agent and resin, and further contains a crosslinking agent, a coupling agent, or the like to impart adhesiveness.

In a case where the wavelength selective absorption filter according to the embodiment of the present invention also serves as the adhesive layer, the adhesive layer preferably contains 90% to 99.94% by mass of the above-described resin, and more preferably contains 95% to 99.7% by mass of the above-described resin. A content of the coloring agent is as described above.

A thickness of the adhesive layer is not particularly limited, but is preferably 1 to 50 μm and more preferably 3 to 30 μm.

### Liquid Crystal Cell

The liquid crystal cell is not particularly limited, and a normal liquid crystal cell can be used.

### OLED Display Device

The organic electroluminescent display device according to the embodiment of the present invention (referred to as an organic electroluminescent (EL) display device or an organic light emitting diode (OLED) display device, and abbreviated as an OLED display device in the present invention) includes the wavelength selective absorption filter according to the embodiment of the present invention.

As another configuration of the OLED display device according to the embodiment of the present invention, the configuration of the generally used OLED display device can be used without particular limitation, as long as the wavelength selective absorption filter according to the embodiment of the present invention is included. The configuration example of the OLED display device according to the embodiment of the present invention is not particularly limited; and examples thereof include a display device including glass, a layer containing a thin film transistor (TFT), an OLED display element, a barrier film, a color filter, glass, a pressure sensitive adhesive layer, the wavelength selective absorption filter according to the embodiment of the present invention, and a surface film, in order from the opposite side to external light.

The above-described OLED display element has a configuration in which an anode electrode, a light emitting layer, and a cathode electrode are laminated in this order. In addition to the light emitting layer, a hole injection layer, a hole transport layer, an electron transport layer, an electron injection layer, or the like is included between the anode electrode and the cathode electrode. In addition, for example, the description of JP2014-132522A can also be referred to.

Furthermore, as the above-described color filter, in addition to a typical color filter, a color filter in which quantum dots are laminated can also be used.

A resin film can be used instead of the above-described glass.

In the present invention, since the wavelength selective absorption filter according to the embodiment of the present invention can be included as it is, the glass and the adhesive layer provided on the external light side of the above-described color filter can be omitted, and the configuration can be adopted in which a glass, a layer containing a thin film transistor (TFT), an OLED display element, a barrier film, a color filter, the wavelength selective absorption filter according to the embodiment of the present invention (the substrate film and the wavelength selective absorption filter layer), and a surface film are included in order from the opposite side with respect to the external light. In addition, the above-described surface film can be omitted, and a configuration in which a glass, a layer including a thin film transistor (TFT), an OLED display element, a barrier film, a color filter, glass, an adhesive layer, and the wavelength selective absorption filter according to the embodiment of the present invention (the wavelength selective absorption filter layer and the substrate film) are provided in this order from the opposite side with respect to the external light can also be adopted.

### Adhesive Layer

In the OLED display device according to the embodiment of the present invention, the surface of the wavelength selective absorption filter according to the embodiment of the present invention on the external light side may be bonded to a light-functional film having an antireflection layer or the like through an adhesive layer. In addition, it is preferable that the surface of the wavelength selective absorption filter according to the embodiment of the present invention, which is positioned on a side opposite to the external light side, is bonded to glass (base material) through an adhesive layer.

For the above-described adhesive layer, the descriptions related to the adhesive layer and the forming method in the OLED display device, which are described in to of WO2021/132674A, can be adopted as they are.

An adhesive composition described in WO2021/132674A preferably contains an ultraviolet absorber from the viewpoint of light resistance of the wavelength selective absorption filter.

### Substrate

In the OLED display device according to the embodiment of the present invention, the wavelength selective absorption filter according to the embodiment of the present invention may be bonded to the light-functional film through the adhesive layer on a surface positioned on the external light side. In addition, it is preferable that the wavelength selective absorption filter according to the embodiment of the present invention is bonded to glass (base material) through the adhesive layer on a surface positioned on a side opposite to the external light side.

A method for forming the above-described adhesive layer is not particularly limited, and for example, a method of applying the adhesive composition onto the wavelength selective absorption filter according to the embodiment of the present invention by a usual method such as a bar coater, drying, and curing the adhesive composition; a method of applying the adhesive composition first onto the surface of a peelable base material, and drying the adhesive composition, and then transferring the adhesive layer using the peelable base material to the wavelength selective absorption filter according to the embodiment of the present invention and then aging and curing the adhesive composition is used.

The peelable base material is not particularly limited, and a predetermined peelable base material can be used. Examples thereof include the substrate film in the manufacturing method of the wavelength selective absorption filter according to the embodiment of the present invention described above.

In addition, the conditions of application, drying, aging, and curing can be appropriately adjusted based on a conventional method.

### Examples

Hereinafter, the present invention will be described in more detail with reference to the examples. The materials, the used amounts, the proportions, the treatment contents, the treatment procedures, and the like described in the following examples can be appropriately changed without departing from the gist of the present invention. Therefore, the scope of the present invention is not limited to Examples.

### Production of Wavelength Selective Absorption Filter

Materials used for a wavelength selective absorption filter are shown below.

### Matrix Resin

(Resin 1):
random copolymer of cyclohexyl methacrylate-methacrylic acid, content of methacrylic acid constitutional unit in all constitutional units of polymer: 29% by mole, weight-average molecular weight: 26,300
(Resin 2):
commercially available polystyrene resin (manufactured by PS Japan Corporation, product name: SGP-10, glass transition temperature (Tg): 100° C.)
(Resin 3):
commercially available styrene-acrylic acid copolymer (manufactured by Toagosei Co., Ltd., product name: ARUFON UC-3920, content of acrylic acid constitutional unit in all constitutional units of polymer: 40% by mole)

### Coloring Agent

A coloring agent compound A (coloring agent A) having the following structure was used.

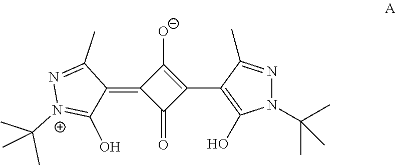 [SMILES: CC1=N[N+](C(C)(C)C)=C(O)/C1=C1\C(=O)C(c2c(C)nn(C(C)(C)C)c2O)=C1[O-]]

### Leveling Agent 1

A polymer surfactant composed of the following constitutional components was used as a leveling agent 1. In the following structural formulae, a proportion of each constitutional component is a molar ratio, and t-Bu means a tert-butyl group.

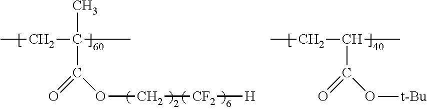

### Substrate Film

### Substrate Film 1

A commercially available polyethylene terephthalate film XD-510P (product name, film thickness: 50 um, manufactured by Toray Industries, Inc.) was used as a substrate film 1.

### Production of Wavelength Selective Absorption Filter No. 101

### Preparation of Resin Solution

Each component was mixed according to the following formulation to prepare a wavelength selective absorption filter layer-forming liquid (composition) Ba-1. Formulation of wavelength selective absorption filter layer-forming liquid Ba-1

| | | |
|---|---|---|
| Resin 1 | 100 | parts by mass |
| Coloring agent A | 3.3 | parts by mass |
| Leveling agent 1 | 0.083 | parts by mass |
| Methyl ethyl ketone (solvent) | 584 | parts by mass |

Subsequently, the obtained wavelength selective absorption filter layer-forming liquid Ba-1 was filtered through a filter paper (#63, manufactured by TOYO ROSHI KAISHA, LTD.) having an absolute filtration precision of 10 μm, and further filtered through a metal sintered filter (FH025, manufactured by Pall Corporation) having an absolute filtration precision of 2.5 μm.

### Production of Wavelength Selective Absorption Filter

The wavelength selective absorption filter layer-forming liquid Ba-1 after the above-described filtration treatment was applied onto the substrate film 1 using a bar coater so that the film thickness after drying was 1.5 μm, and dried at 100° C. to form a wavelength selective absorption filter layer, thereby producing a wavelength selective absorption filter No. 101 according to the embodiment of the present invention.

Production of Wavelength Selective Absorption Filter Nos. 102 and c201

A wavelength selective absorption filter No. 102 according to the embodiment of the present invention and a wavelength selective absorption filter No. c201 of Comparative Example were obtained in the same manner as in the production of the wavelength selective absorption filter No. 101, except that the type of the matrix resin was changed as shown in the table below.

### Evaluation of Wavelength Selective Absorption Filter

An absorption maximal wavelength of the wavelength selective absorption filter according to the present invention and Comparative Example was measured by the following method, and adhesiveness was evaluated by measuring a peeling force. The results are summarized in the tables below.

### Measurement of Absorption Maximal Wavelength of Wavelength Selective Absorption Filter

An absorbance of the wavelength selective absorption filter in a wavelength range of 400 nm to 800 nm was measured at intervals of 1 nm by a UV3150 spectrophotometer (product name) manufactured by Shimadzu Corporation. A difference in absorbance between an absorbance of the wavelength selective absorption filter at each wavelength and an absorbance of a wavelength selective absorption filter containing no coloring agent (matrix resin was the same) was calculated, the maximum value of the difference in absorbance was defined as an absorption maximal value, and a wavelength at which the absorption maximal value was exhibited was defined as the absorption maximal wavelength (λₘₐₓ).

### Adhesiveness

A 90° peeling test was performed as follows according to Japanese Industrial Standards (JIS) Z-0237 (2022).

Specifically, the wavelength selective absorption filter was cut into a size of 25 mm in width and 150 mm in length, and the wavelength selective absorption filter layer side of the wavelength selective absorption filter was bonded to a glass substrate through an adhesive sheet (manufactured by Soken Chemical & Engineering Co., Ltd., product name: STT-125CK). A trigger (incision with a cutter knife) for peeling was provided at an interface between the substrate film and the wavelength selective absorption filter layer, and using a universal material testing instrument TENSILON RTF-1210 (manufactured by A&D Company, Limited), the substrate film was fixed to one chuck, the glass substrate was gripped by the other chuck, and a peeling force between the wavelength selective absorption filter layer and the substrate film in a case where the substrate film was peeled off in a 90° direction, that is, an average value (average peel strength) of the peeling force at positions peeled off by 20 mm and positions peeled off by 50 mm was measured under conditions of a measurement temperature of 25° C., a relative humidity of 60%, a load cell of 50 N, and a peeling rate of 300 mm/min. Based on the peeling force, the adhesiveness was evaluated based on the following evaluation standard.

### Evaluation Standard

A: peeling occurred with a peeling force of 5 N/25 mm or more, or peeling did not occur under the above-described peeling conditions (the peeling did not occur between the wavelength selective absorption filter layer and the substrate film; and the peeling occurred at a portion of the adhesive used for bonding the wavelength selective absorption filter layer to the glass substrate, or the wavelength selective absorption filter itself was broken).
B: peeling occurred with a peeling force of 1 N/25 mm or more and less than 5 N/25 mm.
C: peeling occurred with a peeling force of less than 1 N/25 mm.

TABLE 1

| | Wavelength selective absorption filter layer | | | | | |
|---|---|---|---|---|---|---|
| | | Coloring agent | | | | |
| | Matrix | | | Blending | | Evaluation |
| No. | resin | Type | λₘₐₓ | amount | Thickness | Adhesiveness |
| 101 | Resin 1 | A | 498 | 3.3 | 1.5 | A |
| 102 | Resin 3 | A | 502 | 3.3 | 1.5 | B |
| c201 | Resin 2 | A | 501 | 3.3 | 1.5 | C |

(Note to table)
λₘₐₓ: indicating the absorption maximal wavelength, in which a unit thereof is nm.
Blending amount: indicating the blending amount of the coloring agent with respect to 100 parts by mass of the matrix resin, in which a unit is part by mass.
Thickness: unit is μm.
The evaluation “A” of the adhesiveness of the wavelength selective absorption filter No. 101 indicates that the filter could not be peeled off under the above-described peeling conditions.

As shown in Table 1, the peeling did not occur in the wavelength selective absorption filter No. 101 formed of the resin 1 containing a carboxy group, and the peeling occurred in the wavelength selective absorption filter No. 102 formed of the resin 3 containing a carboxy group with a peeling force of 1 N/25 mm or more and less than 5 N/25 mm, whereas the peeling occurred in the wavelength selective absorption filter No. c201 formed of the resin 2 containing no carboxy group with a weak peeling force of less than 1 N/25 mm. It was found that, by using, as a matrix resin, the resin of a polymer containing a carboxy group, the adhesiveness between the wavelength selective absorption filter layer and the substrate film (support) could be enhanced.

The present application claims the priority of JP2022-185624 filed in Japan on Nov. 21, 2022, the contents of which are incorporated herein by reference, as a part of the description of the present specification.

What is claimed is:

1. A wavelength selective absorption filter comprising:
a substrate film; and
a wavelength selective absorption filter layer disposed in contact with the substrate film,
wherein the wavelength selective absorption filter layer contains a resin containing a carboxy group, and 0.1 parts by mass or more of a coloring agent having a main absorption wavelength band in a wavelength range of 460 to 520 nm with respect to 100 parts by mass of the resin.

2. The wavelength selective absorption filter according to claim 1,
wherein the coloring agent is a squaraine-based coloring agent represented by General Formula (1), 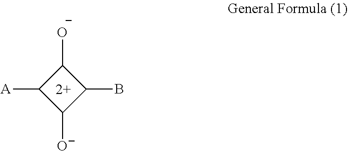
in General Formula (1), A and B each independently represent an aryl group which may have a substituent, a heterocyclic group which may have a substituent, or —CH═G, and G represents a heterocyclic group which may have a substituent.

3. The wavelength selective absorption filter according to claim 1,
wherein a peeling force between the wavelength selective absorption filter layer and the substrate film is 1 N/25 mm or more.

4. A liquid crystal display device comprising:
the wavelength selective absorption filter according to claim 1.

5. An organic electroluminescent display device comprising:
the wavelength selective absorption filter according to claim 1.
